(19) United States
(12) Patent Application Publication
(10) Pub. No.: US 2004/0028565 A1
(43) Pub. Date: Feb. 12, 2004

(54) Automatic pipetting device with rinsing

(76) Inventors: Khaled Abou-Saleh, Courbevoie (FR); Alain Rousseau, Courbevoie (FR)

Correspondence Address: William A Drucker, 1299 Pennsylvania Avenue N W, Washington, DC, 20004, US

(21) Appl. No.: 10/399,428

(22) PCT Filed: Oct. 11, 2001
(86) PCT No.: PCT/FR01/03183

(30) Foreign Application Priority Data
Oct. 24, 2000 (FR) 00/13775

(51) Int. Cl. B32B 5/02

(52) U.S. Cl. 422/100; 422/63; 422/64; 422/65; 422/67

(57) ABSTRACT

The invention concerns a device comprising two cylinder/piston pumping units (1, 2) whereof the rods are driven in translation by common motoring means (MC). The working chamber of said two pumping units (1, 2) is connected to a circuit comprising successively a conduit emerging into a rinsing liquid reserve (RL), two successive electromagnetic valves (EV1, EV2) and a pipe (TS) connected to pipetting means (AP), the larger working chamber being connected in the part of said circuit providing the junction between the electromagnetic valves (EV1, EV2) while the other working chamber is connected in the part of the circuit located between the second electromagnetic valve (EV2) and the pipetting means (AP).

### BACKGROUND OF THE INVENTION

1. Field of the Invention

The present invention concerns an automatic pipetting device with rinsing of the pipetting, this device permitting the restoring of reactive agents and being able to be used in an analysis robot.

It more particularly concerns a device of this type having a modular structure enabling it to be easily adapted according to the required precision and specifications as regards the quantities of products sampled in the pipette and the quantities of rinsing liquid used.

2. Description of the Prior Art

Generally speaking, a large number of devices have been considered for carrying out pipette and rinsing cycles, particularly inside an automatic analysis device.

These devices normally introduce at least two motorisations, one being used to activate a dosing syringe, whereas the other is used to drive in rotation a pump for injecting rinsing liquid. In fact, the dosing syringe provided for small quantities of liquid does not have sufficient capacity to carry out rinsing.

This solution therefore proves to be relatively complex and expensive. It introduces a pump whose motorisation is costly in terms of energy and whose fragility and period of life are less effective than those of a syringe. The reliability of the assembly is thus not everything expected. Now this type of device needs to be able to function without requiring any maintenance for at least seven years at the rate of the robot on which it is used. In the case of a robot of the type described in the patent FR 2 779 827, this rate is 60 tests per hour for at least two hours per day and 220 days per year (that is, about 185000 tests).

Furthermore, one drawback of this solution consists in that it only allows pipette samplings in a single precision range dependent on the dimensions of the syringe without it being possible to adapt it to other precision ranges.

### OBJECT OF THE INVENTION

Therefore, the object of the invention is to provide first of all a pipetting device having a simple structure using only a single motorisation for pipette sampling and rinsing and whose reliability and period of life is similar to those of the pipette syringe so as to obtain optimal reliability of the assembly with the possibility of changing the precision range.

The invention also concerns a pipetting device whose structure and kinematics allow a modularisation of the pipette and rinsing elements so as to be able to obtain great flexibility of usage.

### SUMMARY OF THE INVENTION

So as to obtain these results, the pipetting device of the invention includes at least two pumping units having different dimensions, these two pumping units each including a cylindrical cavity inside which a rod/piston unit slides with imperviousness, said unit delimiting with said cavity a working chamber whose volume varies according to the axial position of the rod/piston unit.

The extremities of the two rod/piston units coming out of the two cavities are coupled to an activation element driven in translation by a common motorisation.

The working chamber of each of the pumping units is moreover connected to a circuit successively including a pipe opening into a rinsing liquid reserve, two successive electrovalves and a tube, possibly flexible, connected to pipetting means, such as a needle.

The largest working chamber is then connected into the circuit portion ensuring the joining point between the two electrovalves, whereas the other working chamber is connected into the circuit portion situated between the second electrovalve and the pipetting means.

Of course, the device of the invention can in addition include means for controlling motorisation and the electrovalves designed so as to provide a cycle including at least:

a pipetting phase in which the first electrovalve is open, the second electrovalve is closed and the motorisation drives in translation the two rod/piston units so as to increase the volume of the two working chambers, the increase of volume of the small chamber generating sucking up of the liquid to be analysed or of the reactive agent in the pipetting means, whereas the increase of volume of the large chamber provokes sucking up of the rinsing liquid inside this chamber,

a delivery phase in which the two electrovalves are in the same state as during the pipetting phase, the motorisation then acting in such a way so as to provoke a reduction of the volumes of said working chambers and a delivery flow of the liquid to be analysed or of the reactive agent.

a rinsing phase in which the first electrovalve is closed, whereas the second is open, the motorisation driving in translation the two rod/piston units so as to reduce the volume of the two working chambers by expelling the rinsing liquid they contain towards the pipetting means.

Of course, the device of the invention could include a number n of pumping units whose rod/piston units are connected to a given activation element and whose working chambers are respectively connected to a circuit including a number n of electrovalves in series respectively connected in the circuit portions ensuring the joining points between the electrovalves concerning the n−1 first valves, the smaller working chamber of the n^{th} valve being connected to the circuit portion situated between this n^{th} electrovalve and the pipetting means. Said control means are then designed in such a way that in each of said phases a specific number i of electrovalves is found in a closed state whereas the other valves, namely a number n−i, are found in an open state.

Advantageously, the device of the invention could include a plurality of modules each including one pumping unit of the said type whose working chamber is connected to a circuit portion including one electrovalve. This circuit portion then includes at each of its extremities means for connecting to the circuit portion of another module and/or to the pipe opening into the rinsing liquid reserve and/or to the tube connected to the pipetting means. The coupling means between the motorisation and the rod/piston units are then designed to allow coupling of the number of the desired modules.

### BRIEF DESCRIPTION OF THE DRAWINGS

Embodiments of the invention are described hereafter given by way of non-restrictive examples with reference to the accompanying drawings on which:

FIG. 1 is a skeleton diagram of a pipetting device conforming to the invention using two syringes.

FIG. 2 is a timing diagram of a complete operating sequence of the pipetting device shown on FIG. 1.

FIG. 3 is a diagrammatic cutaway view of an embodiment of the device shown on FIG. 1.

FIG. 4 is an exploded perspective view of the embodiment shown on FIG. 3.

FIG. 5 is a perspective view of the device of FIG. 4 in an assembled state.

FIG. 6 is diagrammatic cutaway view of a modular pumping unit able to be used in a pipette device conforming to the invention.

FIG. 7 is a diagrammatic representation of the pumping unit of FIG. 5.

### DESCRIPTION OF THE PREFERRED EMBODIMENTS

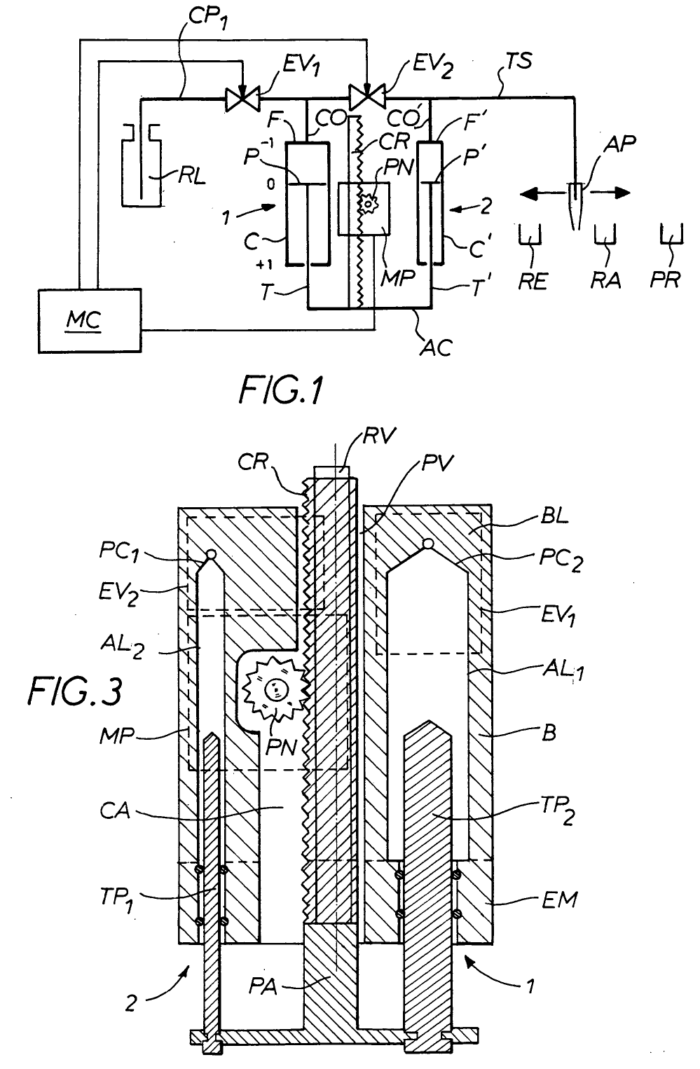

In the example shown on FIG. 1, the pipetting device includes two pumping units 1, 2 each including a cylindrical body C, C′ in which a piston P, P′ moves and which delimits with a bottom F, F′ a variable volume working chamber.

This piston is integral with a rod T, T′ coming out of the body on the side opposite to the bottom F and which is coupled to a translation activation mechanism introducing:

a coupling element AC on which the rods T and T′ are fixed (there is a play between T, T′ and AC to mitigate any defects of parallelism),

a rack CR integral with the coupling element AC which extends parallel to the axis of the cylindrical bodies C, C′.

a pinion PN driven by a step motor MP which gears with the rack CR.

The bottom of each of the bodies C, C′ is fitted with a piper CO, CO′ making the corresponding working chamber communicate with a circuit including in series a pipe CP₁ opening into a rinsing liquid reserve RL, two successive electrovalves EV₁, EV₂ and a flexible tube TS connected to a mobile pipetting needle AP. This needle AP is activated so as to be able to be engaged in various receptacles, such as, for example as shown, a reserve RE containing a sample or a reactive agent, an analysis receptacle RA and a rinsing chamber PR.

More specifically, the pipe CO is connected to the circuit in the gap of the electrovalves EV₁, EV₂. The pipe CO′ opens into the circuit portion ensuring the joining point between the electrovalve EV₂ and the needle AP.

Control of the electrovalves EV₁, EV₂ and of the motor MP is ensured by a microcontroller MC. The optical sensor only furnishes the “zero” position of the system.

In this example, the state of the valve EV₁ is still opposite that of the valve EV₂, that is when the valve EV₁ is open, the valve EV₂ is closed and vice versa.

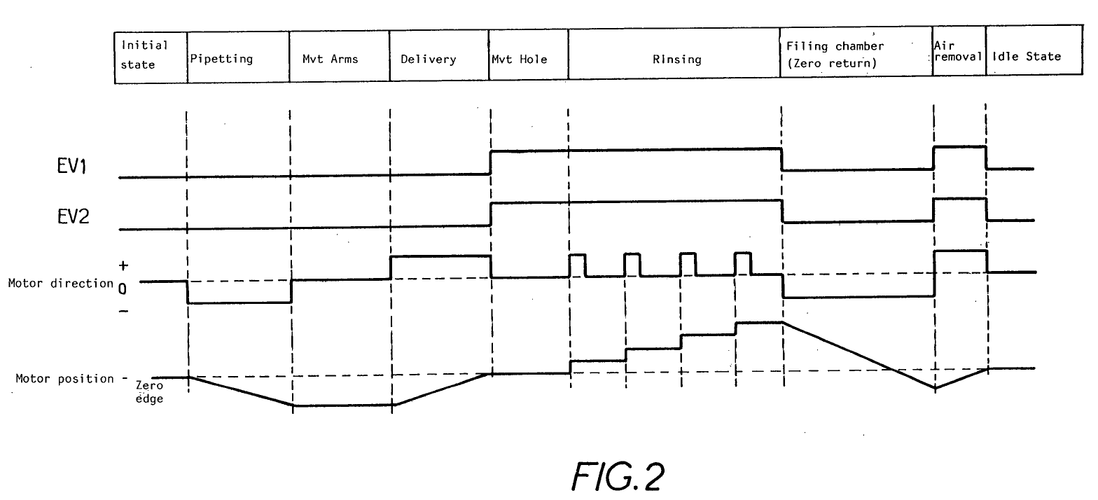

The functioning of the pipetting device previously mentioned shall be described hereafter with reference to the timing diagram of FIG. 2.

According to this timing diagram, in the initial state, the needle AP is engaged in the reserve RE, the valves EV₁, EV₂ being respectively situated in the open and closed positions. The motor MP is inactive, the pistons being in the idle position (position 0). The two working chambers of the pumping units are filled with rinsing liquid.

The pipetting phase is then carried out by means of a rotation of the motor MP (negative direction) so as to move the two pistons P, P′ downwards. During this movement, the piston P′ creates suction of the liquid contained in the reserve RE inside the needle AP and one portion of the flexible tube TS, whereas the piston P sucks up the rinsing liquid contained in the reserve RE.

During the next phase, the needle PA is moved for example so as to be placed above the analysis receptacle RA.

Once in this position, the device can start the delivery phase during which the motor MP rotates in the opposite direction so as to put the pistons P, P′ back to their idle positions (position 0). Whilst this is happening, the electrovalves stay in the same sate as previously and the piston P′ delivers the liquid, previously taken in the needle AP, inside the receptacle RA, whereas the piston P delivers the rinsing liquid inside the reserve.

Once this delivery phase has ended, the needle AP is brought to the right of the rinsing chamber PR so as to allow execution of a rinsing phase.

During this new phase, the state of the electrovalves is inverted, the electrovalve EV₁ being closed and the electrovalve EV2 open, whereas the motor MP is activated so as to deliver the rinsing liquid contained in the two syringes in the direction of the pipetting needle.

In fact, this delivery takes place in several stages each corresponding to one or several steps of the motor MP.

Once the rinsing phase has been completed, the device starts a filling phase during which the electrovalve EV₁ is open, whereas the electrovalve EV₂ is closed. The motor MP is then activated so as to move the pistons P, P′ downwards to provoke the required suction. During this filling phase, the pumping unit 2 provokes sucking up of air by the needle AP.

As a result, the return of the device to its initial state involves an air evacuation phase during which the electrovalves EV₁, EV₂ are respectively closed and open and the motor MP is activated so as to obtain a delivery of the rinsing liquid contained in the units 1 and 2 through the needle.

When the air is removed, the device returns to its initial state in which the electrovalves EV₁, EV₂ are respectively in the open state and closed state and where the pistons occupy the idle position 0.

Advantageously, the previously described device could be dimensioned so as to be able to be compatible with currently used analysis robots.

By way of example, in this device used on a robot as described in FR 2 779 827:

the minimum volume to be pipetted could be equal to 5 μl, the maximum volume being equal to 250 μl, (this volume being determined by adjusting the number of steps of the motor during the suction and covering phases);

for restoring the reactive agents, the maximum volume to be pipetted could be equal to 8 ml,

the start delivery rate could be 24.4 μl/s or 73.2 μl/s, the upper delivery rate being about 366 μl/s,

The device could be made to carry out 10 successive rinsings with a volume of 150 μl with a duration of 100 ms per one rinsing. The pressure of the rinsing stages could be 3 bars,

The motor MP used may consist of a step back-geared motor including 200 steps per revolution,

The diameter of the piston of the body of the pipetting unit 1 could be equal to 14 mm, whereas the diameter of the piston of the body of the pipetting unit 2 could be 3 mm,

The length of the two bores could be 55 mm.

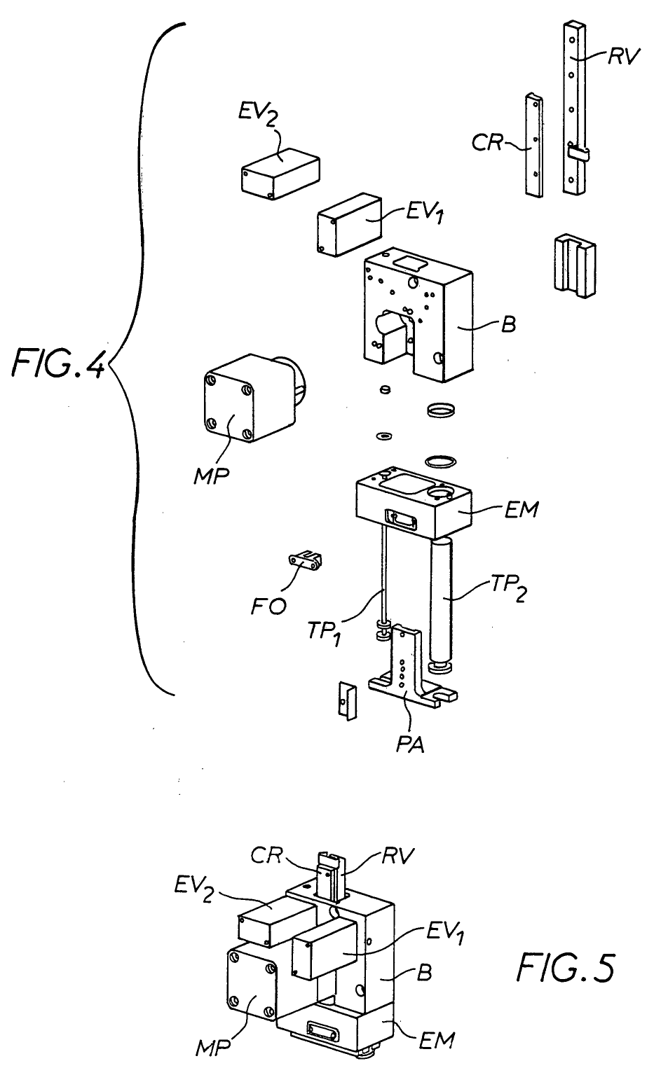

In the example shown on FIGS. 3, 4 and 5, the bodies of the two pipetting units 1, 2 are integrated in a given plastic block BL made, for example of Plexiglas (registered trademark) having an approximately parallelepiped shape.

This body includes two bores AL₁, AL₂ centered parallel to the vertical axis of symmetry of the block, said bores opening outside the level of the lower face of the block. In their upper portion, these two bores end by two respective conical portions PC₁, PC₂ situated at a specific distance from the upper face.

In the volume between the two bores AL₁, AL₂, a cavity CA is provided which opens onto the lower face and the front face, as well as a vertical passage PV extending between the upper face of the cavity CA and the upper face of the block.

Secured to the lower face of the block is a base EM including two traversing vertical passages in which mounted sliding imperviously are two respective rod/piston units TP₁, TP₂ made for example of stainless steel respectively engaged in the bores AL₁, AL₂, sliding imperviousness here being obtained with the aid of dynamic gaskets.

The upper extremities of these rod/piston units are conical, whereas their lower extremities include two respective throats enabling them to be fixed to the extremities of a horizontal branch of an inverted T actuation element PA and enabling them to be dismantled.

The vertical branch of this actuation element PA is fixed to the lower extremity of a vertical rail RV able to move in vertical translation and which passes into the cavity by means of an orifice provided in the base and then through the passage PV.

This rail RV bears a rack CR on which the pinion PN gears, said pinion being activated by a back-geared motor (block at the broken points MP) and which is housed in the cavity.

Moreover, two electrovalves EV₁, EV₂ are mounted on the front face of the body in communication with pipes made in the block B in accordance with the circuit shown on FIG. 1.

In addition, an optical fork FO is provided for detecting the “zero” position of the rail RV.

The functioning of this device is identical to the one previously described and shall not be described here in detail.

Nevertheless, it proves that this solution is particularly advantageous owing to its compactness, its ease of integration, its aptitude to eliminate the bubbles by means of the conical shapes, its precision which depends on that of the rod/piston units TP₁, TP₂ which can be machined at an extremely high-performance precision, and its reliability.

In particular, the elimination of bubbles is due both to the conical shapes of the rod/piston units TP₁, TP₂ and the cylindrical bores AL₁, AL₂, as well as the surface state of these elements. Furthermore, the passage of bubbles is facilitated due to the fact that the conical shape PC, of the cylindrical bore AL₂ with the smaller diameter communicates directly with the pipe connected to the pipetting means AP.

Of course, the invention is not limited to employing this solution.

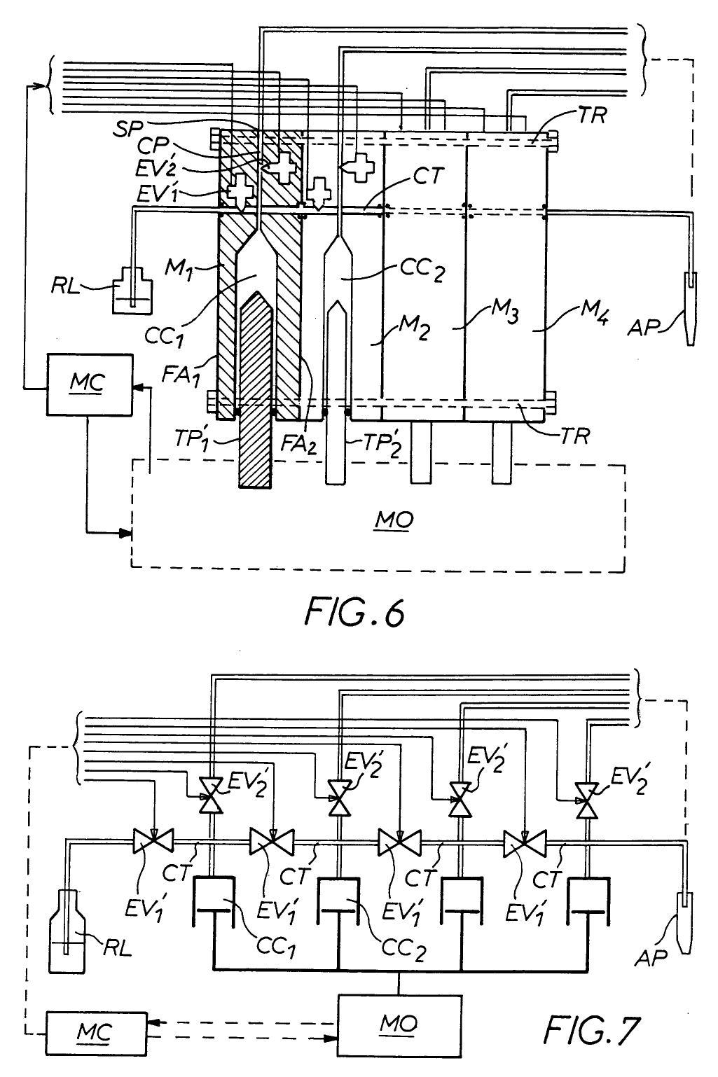

It also concerns a modular device using pumping modules able to be assembled to each other in the way indicated on FIGS. 6 and 7.

In this example, each module M₁ to M₄ includes a cylindrical cavity CC₁, CC₂ in which a rod/piston unit TP′₁, TP′₂ activated by a motorisation (block MO) common to all the rod/piston units TP′₁, TP′₂ is able to slide imperviously.

This module includes a body having two parallel assembling faces FA₁, FA₂ into which a traversing pipe CT opens, in communication with the cylindrical cavity CC₁ and having one portion able to be sealed off by a needle activated by an electromagnet (the unit constituting an electrovalve EV′₁).

At the level of the assembly faces, the orifices of this pipe CT are equipped with connection means for the sealed connection of pipe sections CT of several modules when the latter are assembled together via their assembly faces and fixed in this position, for example by tie rods TR.

Similarly to the foregoing, the pipe obtained by the connection of the various traversing pipes CT is connected on one side to the rinsing liquid receptacle RL, and on the other side to a pipetting needle AP.

The electrovalves EV′ and the motorisation MO are connected to a microprocessor control circuit MC.

In addition, each of the modules M₁ to M₄ also includes a pipe CP in communication with the cylindrical cavity CC₁ and which opens onto the upper face of the module via an orifice constituting a parallel outlet SP. This pipe CP can be sealed off by a needle controlled by an electromagnet, the unit forming an electrovalve EV′₂ similar to the electrovalves EV′₁ and controlled by the control circuit.

This parallel outlets SP can be connected to the pipette needle AP by means of a common collector.

It is clear that this modular structure benefits from its extreme flexibility and can be adapted to a large number of situations by varying the number of modules, by selecting modules having cavities with a suitable diameter, by grouping modules having electrovalves exhibiting the same states, by selecting the outlets most suitable for carrying out the desired functions, etc. Of course, this selection can be provided by a programme implemented by the control circuit MC.

1. Automatic pipetting device with rinsing, this device allowing the restoration of reactive agents and being able to be used in an analysis robot, comprising at least two pumping units of different capacities, each comprising a cylindrical cavity inside which a rod/piston unit slides imperviously, said unit delimiting with said cavity a working chamber whose volume varies according to the axial position of the rod/piston unit, in that the extremities of the two rod/piston units coming out of the two cavities are coupled to an actuation element moved in translation by a common motorisation, wherein the working chamber of each of said pumping units is connected to a circuit successively including a pipe opening into a rinsing liquid reserve, two successive electrovalves and a tube connected to pipetting means, the largest working chamber being connected in the portion of said circuit ensuring the joining point between the two electrovalves, whereas the smallest working chamber is connected in the circuit portion situated between the second electrovalve and the pipetting means.

2. Device according to claim 1, comprising control means of the motorisation and electrovalves designed so as to obtain a cycle comprising at least:
one pipetting phase in which the first electrovalve is open, the second electrovalve is closed and the motorisation drives in translation to two rod/piston units so as to increase the volume of the smallest working chamber and generate suction of a liquid to be sampled by the pipetting means and an increase of the volume of the largest chamber provoking suction of the rinsing liquid inside this largest chamber,
a delivery phase in which the two electrovalves are in the same state as during the pipetting phase, the motorisation then acting in a way to provoke a volume reduction of said working chambers and a delivery of the liquid previously sampled, and
a rinsing phase in which the first electrovalve is closed, whereas the second electrovalve is open, the motorisation moving in translation the two rod/piston units so as to reduce the volume of the working chambers by expelling the rinsing liquid they contain towards the pipetting means.

3. Device according to claim 2, wherein, following the rinsing phase, said cycle comprises a filling phase during which the second electrovalve is closed, whereas the first electrovalve is open, the motor being activated so as to increase the volume of said working chambers, and an air removal phase during which said first and second electrovalves are respectively closed and open, whereas the motorisation is activated so as to obtain a delivery of the rinsing liquid in the direction of the pipetting means.

4. Device according to claim 1, wherein the cylindrical cavities of the two pumping units are embodied in a given material block.

5. Device according to claim 1, wherein said motorisation comprises a motor driving a pinion which gears with a rack integral with said activation member.

6. Device according to claim 1, wherein the upper extremities of the cylindrical cavities and the rod/piston units are conical.

7. Device according to claim 6, characterised in that the conical shape of the smallest cylindrical cavity communicates directly with the pipe connected to the pipetting means.

8. Device according to claim 1, wherein said pumping units consist of modules each including a body having two parallel assembling faces into which a traversing pipe opens, said pipe being in communication with said cylindrical cavity and having one portion able to be sealed off by an electrovalve, the orifices of said pipe being equipped with connection means for ensuring sealed connection with a corresponding orifice of another module when the two modules are assembled to each other via their assembling faces and fixed in this position with the aid of fixing means, said orifices moreover being able to be connected either to the rinsing liquid intake pipe or to the pipe connected to the pipetting means.

9. Device according to claim 8, wherein each of the modules includes a pipe in communication with the cylindrical cavity and which opens outwardly by an orifice constituting a parallel outlet, said pipe being able to be sealed off by an electrovalve.

10. Device according to claim 1, wherein said electrovalves and said motorisation are controlled by a processor receiving information relating to the position of the rod/piston units.

11. Device according to claim 10, wherein said information is obtained with the aid of an optical fork associated with said rack.
